(19) United States
(12) Patent Application Publication
(10) Pub. No.: US 2026/0287407 A1
(43) Pub. Date: Sep. 24, 2026

(54) METHOD FOR ESTIMATING VOLUME AND PRESSURE IN A TANK, AND PRESSURE LOSSES CONNECTED WITH A DISPENSING STATION

(71) Applicant: L'Air Liquide, Société Anonyme pour l'Etude et l'Exploitation des Procédés Georges Claude, Paris (FR)

(72) Inventors: Remi GONIN, Jouy-en-Josas (FR); Fouad AMMOURI, Massy (FR); David VEMPAIRE, Sassenage (FR)

(21) Appl. No.: 19/558,143

(22) Filed: Mar. 5, 2026

(30) Foreign Application Priority Data
Mar. 19, 2025 (FR) FR2502801

(51) Int. Cl. G01F 17/00; F17C 5/06; F17C 13/02; G01F 22/02

(52) U.S. Cl. CPC G01F 17/00; F17C 5/06; F17C 13/023; F17C 13/028; G01F 22/02; F17C 2250/043; F17C 2250/0443; F17C 2250/0491

(57) ABSTRACT

Method (10) for estimating the volume (V) of a pressurized gas tank (2) and the pressure (Pₜₐₙₖ) of the gas in said tank (2), the tank (2) being supplied by a dispensing station (1) comprising, in this order: a source (3) of said gas, a control valve (7), and a dispenser (5) connected to the tank (2), the method (10) comprising a step (S5) of determining the volume (V) of the tank (2) and the pressure (Pₜₐₙₖ) of the gas in the tank (2) through an iterative search for the root of a function (P) expressing the difference between the pressure (Pₜₐₙₖ) of the gas in the tank (2) and a value (P_{tank_mes}) for the gas pressure (P_{disp}) measured at the dispenser (5), the iterative search being performed within an interval ([Vₘᵢₙ, Vₘₐₓ]) that is defined between a minimum reference volume (Vₘᵢₙ) and a maximum reference volume (Vₘₐₓ).

### CROSS REFERENCE TO RELATED APPLICATIONS

This application claims the benefit of priority under 35 U.S.C. § 119 (a) and (b) to French Patent Application No. FR2502801, filed Mar. 19, 2025, the entire contents of which are incorporated herein by reference.

### BACKGROUND

The invention relates to a method for estimating the volume of a pressurized gas tank and the pressure of the gas contained in such a tank. The pressurized tank may be supplied from a dispensing station.

The invention also relates to a method for estimating hydraulic pressure losses between a pressurized gas tank and a dispensing station. The pressure losses are determined from the pressure of the gas in the tank, as estimated according to a method of the invention.

The gas considered in the context of the present invention may be hydrogen supplied to a tank (Compressed Hydrogen Storage System-CHSS) of a Fuel Cell Vehicle (FCV). The dispensing station may be a hydrogen dispensing station or Hydrogen Refuelling Station (HRS).

Before filling a tank with hydrogen from a dispensing station HRS, it is necessary to know precisely the total volume of this tank, notably in order to determine the category of tank and accordingly select the most suitable filling protocol. The data item relating to the volume of the tank also enables the application of a safety method such as the one described in patent application FR2207428.

There are various ways of estimating the total volume of the vehicle tank supplied from a dispensing station. These methods rely upon a physical model of the thermodynamic behaviour of the gas in the tank and notably use pressure, temperature and mass flow rate data, these being measured at a dispensing point of the station, referred to as the dispenser. These data are measured during the course of a short initial step of the filling referred to as the “volume estimation step”.

While these methods have the advantage of enabling the volume to be calculated directly without requiring a great deal of computation resources, they do require, for accurate results, knowledge of how the pressure and the mass of the gas in the tank evolve. These methods may entail knowledge of the geometric parameters and of the properties of the materials of the tank, of the injector, and of the hydraulic pipe between the dispenser and the tank. The data relating to the aforementioned parameters and properties are generally inaccessible from the dispensing station.

Moreover, for stopping the filling of a tank, the criterion used for stopping in dispensing stations is generally based on the pressure measured in the dispenser, there being no available data relating to the actual pressure of the gas in the tank. With such a criterion for stopping, the state-of-charge SOC (which reflects the degree of filling) cannot be precisely known and the maximum state of charge is not reached.

Now, by using a known head loss coefficient kᵥ for a hydraulic pipe belonging to the filling station, it would be possible to determine the pressure Ptank of the gas in a tank, the characteristics of which are theoretically unknown, even where there is no communication between the vehicle and the filling station.

A criterion for stopping could then be defined on the basis of the pressure Ptank in the tank, and this would lead to a state of charge close to the maximum state of charge. Such a criterion for stopping would enable the dispensing station to dispense more gas to the tank and provide the latter with a greater range before needing to be refilled.

### SUMMARY

One object of the invention is to propose a method for estimating the volume of a pressurized gas tank and the pressure of the gas contained in this tank. The method will need to provide a value for the volume and a value for the pressure that are more precise than those provided by the methods of the prior art.

Another object of the invention is to determine the pressure losses associated with a hydraulic pipe belonging to a dispensing station, by relying on the gas-pressure data item determined according to the aforementioned method.

To this end, a first aspect of the invention relates to a method for estimating the volume V of a pressurized gas tank and the pressure Ptank of the gas in said tank, the tank being supplied by a dispensing station comprising, in this order: a source of said gas, a control valve and a dispenser which is connected to the tank, the method comprising the following steps:
a) measuring SO a first value Ptank_mes for the pressure Ptank of the gas in the tank by measuring the pressure P_{disp} of the gas at the dispenser, the control valve being closed,
b) injecting S1 a quantity Δm of gas into the tank,
c) determining S2 during the injection S1 a value for the mass flow rate m, a value for the pressure Pdisp and a value for the temperature Tdisp of the gas at the dispenser; and a value for the ambient temperature Tamb in a region surrounding the tank,
d) measuring S3 a second value P_{tank_mes} for the pressure Ptank of the gas in the tank by measuring the pressure P_{disp} of the gas at the dispenser, the control valve being closed,
e) determining S4 a maximum volume Vₘₐₓ corresponding to a first reference tank, and a minimum volume Vₘᵢₙ corresponding to a second reference tank,
f) determining S5 the volume V of the tank and the pressure Pₜₐₙₖ of the gas in the tank, through an iterative search for the root of a function P expressing the difference between the pressure Pₜₐₙₖ of the gas in the tank and the second value P_{tank_mes} for the gas pressure P_{disp} measured at the dispenser during the measurement S3, the iterative search being performed in an interval [Vmin, Vmax] that is defined between the minimum volume Vmin and the maximum volume Vmax.

In the above-mentioned function P, the pressure Pₜₐₙₖ of the gas in the tank constitutes the variable. The root of the function P is the value for the pressure Pₜₐₙₖ at which the function P equals zero. The root of the function P is also referred to as the “zero” of the function P.

Thanks to the iterative search, the volume of the tank and the pressure of the gas in the tank have values that are more precise than those obtained directly from a simplified physical model such as the one described in patent application number 2307995.

Embodiments of the invention may have one or more of the following features:
the maximum volume Vmax and the minimum volume Vmin respectively have predefined fixed values,
the maximum volume Vmax and the minimum volume Vmin respectively have values calculated from a physical model in which the first reference tank is considered as having been filled adiabatically and the second reference tank is considered as having been filled isothermally,
the iterative search comprises a step of assigning an approximated value Vi to the volume V of the tank, the approximated value Vi being comprised between the maximum volume Vmax and the minimum volume Vmin,
the iterative search comprises a step of dividing the interval ([Vmin, Vmax]) into two sub-intervals defined with respect to the approximated value Vi, the iterative search also comprising a step of selecting one of said sub-intervals in which to search for the root of the function P,
the iterative search comprises a step of calculating an approximated value Ptank_i for the pressure Ptank of the gas in the tank, said approximated value Ptank_i being calculated from the approximated value Vi for the volume V,
the iterative search comprises a step of calculating the difference between the approximated value Ptank_i for the pressure Ptank of the gas in the tank and the second value Ptank_mes for the gas pressure Pdisp measured at the dispenser in the measurement step S3,
the iterative search comprises a step of incrementing or decrementing the approximated value Vi for the volume V when the difference between the approximated value Ptank_i for the pressure Ptank of the gas in the tank and the second value Ptank_mes for the gas pressure Pdisp measured at the dispenser is nonzero and above a predefined threshold,
when the approximated value Ptank_i for the pressure Ptank of the gas in the tank is higher than the second value Ptank_mes for the gas pressure Pdisp measured at the dispenser, the approximated value Vi for the volume V is incremented by a first predetermined quantity to give a new approximated value Vi+1 for the volume V, a new approximated value Ptank_i+1 for the pressure Ptank of the gas in the tank being calculated from the new approximated value Vi+1 for the volume V, the new approximated value Vi+1 for the volume V and the maximum volume Vmax forming a new sub-interval in which to search for the root of the function P,
when the approximated value Ptank_i for the pressure Ptank of the gas in the tank is lower than the second value Ptank_mes for the gas pressure Pdisp measured at the dispenser, the approximated value Vi for the volume V is decremented by a second predetermined quantity to give a new approximated value Vi−1 for the volume V, a new approximated value Ptank_i−1 for the pressure Ptank of the gas in the tank being calculated from the new approximated value Vi−1 for the volume V, the minimum volume Vmin and the new approximated value Vi−1 for the volume V forming a new sub-interval in which to search for the root of the function P,
the method comprises successive incrementations of the approximated value Vi for the volume V to give successive new approximated values Vi+1 for the volume V, the method also comprising successive calculations of approximated values Ptank_i for the pressure Ptank of the gas in the tank from new successive approximated values Vi+1 for the volume V, the calculations being performed respectively in sub-intervals each formed between an approximated value Vi for the volume and the maximum volume Vmax, the incrementations being repeated for as long as the difference between the approximated value Ptank_i for the pressure Ptank of the gas in the tank and the second value Ptank_mes for the gas pressure Pdisp measured at the dispenser is nonzero, and for as long as the difference between two successive approximated values Vi for the volume V remains above a predefined threshold, the exact value Vf for the volume V of the tank being determined by the last approximated value Vi obtained at the end of the last incrementation, the exact value Ptank_f for the pressure Ptank of the gas in the tank being determined from the exact value Vf for the volume of the tank,
the method comprises successive decrementations of the approximated value Vi for the volume V to give successive new approximated values Vi−1 for the volume V, the method also comprising successive calculations of approximated values Ptank_i for the pressure Ptank of the gas in the tank from the approximated values Vi for the volume V, the calculations being performed respectively in sub-intervals each formed between the minimum volume Vmin and an approximated value Vi for the volume V, the decrementations being repeated for as long as the difference between the approximated value Ptank_i for the pressure Ptank of the gas in the tank and the second value Ptank_mes for the gas pressure Pdisp measured at the dispenser is nonzero, and for as long as the difference between two successive approximated values Vi for the volume V remains above a predefined threshold, the exact value Vf for the volume V of the tank being determined by the last approximated value Vi obtained at the end of the last decrementation, the exact value Ptank_f for the pressure Ptank of the gas in the tank being determined from the exact value Vf for the volume of the tank.

A second aspect of the invention relates to a method for estimating hydraulic pressure losses between a pressurized gas dispensing station and a tank supplied by said station, the station comprising, in this order: a source of said gas, a control valve and a dispenser provided with a hydraulic pipe connected to the tank.

The method comprises a step of calculating the head loss coefficient between the hydraulic pipe and the tank using a function that is dependent upon the following parameters, determined at the dispenser: the flow rate (m), the pressure P_{disp} and the temperature T_{disp} of the gas. The function is also dependent upon the pressure Pₜₐₙₖ of the gas in the tank as calculated by iterative search according to the method described in connection with the first aspect of the invention.

### BRIEF DESCRIPTION OF THE DRAWINGS

The invention will be understood better, and further advantages will become apparent from reading the following description, with reference to the following figures:

FIG. 1 schematically illustrates a vehicle tank connected to a filling station.

FIG. 2 illustrates steps of a method according to the invention for estimating the volume of the tank illustrated in FIG. 1 and the pressure of the gas contained in this tank.

### DETAILED DESCRIPTION OF THE PREFERRED EMBODIMENTS

The invention relates to a method 10 for estimating the volume V of a pressurized gas tank 2 and the pressure Pₜₐₙₖ of the gas contained in said tank 2. The gas in question may be hydrogen. The tank 2 is then a pressurized hydrogen tank or Compressed Hydrogen Storage System (CHSS).

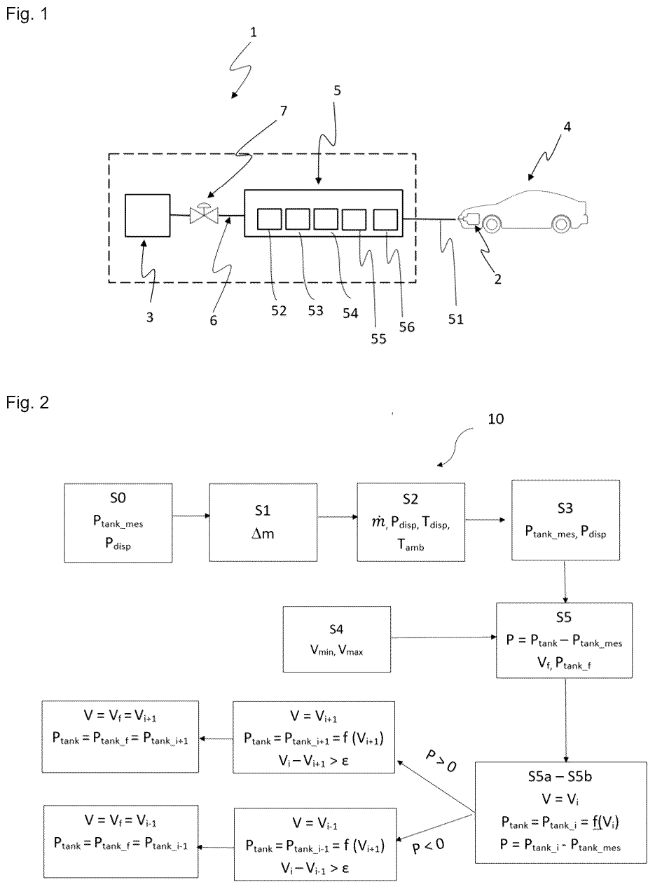

The tank 2 may be that of a fuel cell vehicle 4. This may be a single tank or a collection of tanks with which the vehicle 4 is equipped. Furthermore, the tank 2 may be supplied by a filling station 1, as shown in FIG. 1.

The filling station 1 comprises a gas source 3 and a dispenser 5 intended to accept the vehicle 4.

The dispenser 5 is connected to the gas source 3 by means of a transfer line 6 which comprises at least one control member 7 controlling the pressure and/or the flow rate of the fluid. Furthermore, the dispenser 5 comprises a supply pipe 51 provided at its end with a nozzle intended to be received in a receptacle belonging to the vehicle 4. The dispenser 5 may be equipped with a pressure sensor 52 sensing the pressure of the transferred fluid, with a temperature sensor 53 sensing the temperature of the transferred fluid, with a mass flow rate sensor 54 sensing the mass flow rate of the transferred fluid, with a temperature sensor 55 sensing ambient temperature, and with a valve 56.

The method 10 comprises a step SO of measuring a first value P_{tank_mes} for the pressure Pₜₐₙₖ of the gas in the tank 2 via a measurement of the gas pressure P_{disp} at the dispenser 5. To this end, the control valve 7 positioned between the gas source 3 and the dispenser 5 is closed.

The method 10 also comprises a step S1 of injecting a quantity Δm of gas into the tank 2 by means of the dispenser 5. This injection step S1 extends over a duration Δt defined between an instant to marking the start of the injection step S1 and an instant t₁ marking the end of the injection step S1.

In order to inject gas into the tank 2 from the filling station 1, the control member 7 that controls pressure and/or flow rate, and the valve 56, are kept open.

Method 10 also comprises a step S2 of determining a value for the mass flow rate m, for the pressure P_{disp} and for the temperature T_{disp} of the gas at the dispenser 5; and a value for the ambient temperature Tamb in a region surrounding the tank 2. These values are determined throughout the length of the injection step S1.

After the injection step, the method 10 provides a step S3 of measuring a second value P_{tank_mes} for the pressure Pₜₐₙₖ of the gas in the tank 2 via a measurement of the gas pressure P_{disp} at the dispenser 5. To this end, the control valve 7 is closed.

Moreover, the method 10 comprises a step S4 of determining a maximum volume Vₘₐₓ corresponding to a first reference tank, and a minimum volume Vₘᵢₙ corresponding to a second reference tank.

The first reference tank and the second reference tank may be real tanks of known dimensions. Thus, the maximum volume Vₘₐₓ and the minimum volume Vₘᵢₙ may respectively have predefined fixed values.

As an alternative, the first reference tank and the second reference tank may be virtual tanks in which an adiabatic filling or an isothermal filling have been simulated. Thus, the maximum volume Vₘₐₓ and the minimum volume Vₘᵢₙ may respectively have values calculated from a physical model in which the first reference tank is considered as having been filled adiabatically and the second reference tank is considered as having been filled isothermally.

According to the invention, the method 10 comprises a step S5 of determining the volume V of the tank 2 and the pressure Pₜₐₙₖ of the gas in the tank 2 through an iterative search for the root of a function P expressing the difference between the pressure Pₜₐₙₖ of the gas in the tank 2 and the pressure P_{disp} of the gas at the dispenser 5. The pressure P_{disp} being determined during the measurement step S3 at the instant t₁. The iterative search is performed within an interval [Vₘᵢₙ, Vₘₐₓ] that is defined between the minimum volume Vₘᵢₙ and the maximum volume Vₘₐₓ.

What is meant by an “iterative search” is a numerical method for solving mathematical equations. This may be the bisection method (also known as the binary-search or interval-halving method), the Newton Raphson method, etc.

Advantageously, the iterative search is a binary search.

The iterative search comprises a step S5a of assigning an approximated value Vi to the volume V of the tank 2. This approximated value Vi is comprised between the maximum volume Vₘₐₓ corresponding to the first reference tank and the minimum volume Vₘᵢₙ corresponding to the second reference volume. This approximated value Vi enables the interval [Vₘᵢₙ, Vₘₐₓ] to be divided into two sub-intervals one of which contains the exact value Vf for the volume V.

Moreover, the iterative search comprises a step of assigning an approximated value Pₜₐₙₖ i to the pressure Pₜₐₙₖ of the gas in the tank. The approximated value Pₜₐₙₖ_i for the pressure Pₜₐₙₖ of the gas in the tank 2 is calculated from the approximated value Vi for the volume V.

Once the approximated value P_{tank_i} for the pressure Pₜₐₙₖ is known, the method 10 provides a step S5d of calculating the difference between this approximated value P_{tank_i} and the second value P_{tank_mes} for the gas pressure P_{disp} determined at the dispenser 5. The second value P_{tank_mes} for the pressure P_{disp} of the gas at the dispenser 5 is determined during the measurement step S3 performed at the instant t₁.

When the difference between the approximated value P_{tank_i} for the pressure Pₜₐₙₖ of the gas in the tank 2 and the second value P_{tank_mes} for the pressure P_{disp} of the gas at the dispenser 5 is nonzero and above a predefined threshold, the iterative search provides a step S7 of incrementing or decrementing the approximated value Vᵢ for the volume V.

Thus, when the approximated value Pₜₐₙₖ i for the pressure Pₜₐₙₖ of the gas in the tank 2 is higher than the second value P_{tank_mes} for the gas pressure P_{disp} determined at the dispenser 5, the approximated value Vᵢ for the volume V is incremented by a first predetermined quantity to give a new approximated value Vᵢ₊₁ for the volume V. From the new approximated value Vᵢ₊₁ for the volume V, the iterative search calculates a new approximated value P_{tank_i+1} for the pressure Pₜₐₙₖ of the gas in the tank 2. The new approximated value Vi+1 for the volume V and the maximum volume Vₘₐₓ corresponding to the first reference tank thus form a new sub-interval [Vᵢ₊₁, Vₘₐₓ] for a subsequent search for the root of the function P.

Conversely, when the approximated value Pₜₐₙₖ i for the pressure Pₜₐₙₖ of the gas in the tank 2 is below the second value P_{tank_mes} for the gas pressure P_{disp} determined at the dispenser 5, the approximated value Vᵢ for the volume V is decremented by a second predetermined quantity to give a new approximated value Vᵢ₋₁ for the volume V. From the new approximated value Vᵢ₋₁ for the volume V, the iterative search calculates a new approximated value P_{tank_i-1} for the pressure Pₜₐₙₖ of the gas in the tank 2.

The minimum volume Vₘᵢₙ corresponding to the second reference tank and the new approximated value Vᵢ₋₁ for the volume V form a new sub-interval [Vₘᵢₙ, Vᵢ₋₁] for a subsequent search for the root of the function P.

As long as the difference between the approximated value P_{tank_i} for the pressure Pₜₐₙₖ of the gas in the tank 2 and the second value P_{tank_mes} for the pressure P_{disp} of the gas at the dispenser 5 is nonzero, and as long as the difference between two successive approximated values Vi for the volume V remains above a predefined threshold, the method 10 continues to successively increment or decrement the approximated value Vi for the volume V in order to give new successive approximated values Vᵢ₊₁ or Vᵢ₋₁ for the volume V. The method 10 also provides successive calculations of approximated values P_{tank_i} for the pressure Pₜₐₙₖ of the gas in the tank 2 from the successive approximated values Vi for the volume V.

The successive calculations of approximated values P_{tank_i} for the pressure Pₜₐₙₖ of the gas in the tank 2 are performed respectively in sub-intervals each formed between an approximated value Vi for the volume V and the maximum volume Vₘₐₓ, or sub-intervals each formed between the minimum volume Vₘᵢₙ and an approximated value Vᵢ for the volume V.

The exact value Vi for the volume V of the tank 2 is determined by the last approximated value Vi obtained at the end of the last incrementation or decrementation step. The exact value P_{tank_f} for the pressure of the gas in the tank 2 is calculated from the exact value V_{f} for the volume V.

As indicated previously, the maximum volume Vₘₐₓ and the minimum volume Vₘᵢₙ may respectively have values calculated from a physical model in which the first reference tank is considered as having been filled adiabatically and the second reference tank is considered as having been filled isothermally.

Thus, the minimum volume Vₘᵢₙ can be expressed as follows:

$${V}_{min} = \frac{Δ m}{{ρ}_{gas} ( {T}_{tank} ( {t}_{1} ) , {P}_{disp} ( {t}_{1} ) ) - {ρ}_{gas} ( {T}_{tank} ( {t}_{0} ) , {P}_{disp} ( {t}_{0} ) )}$$

where ρ_{gas} is the density of the gas in the tank 2, Tₜₐₙₖ is the temperature of the gas in the tank 2, P_{disp} is the gas pressure at the dispenser 5, Δm is the quantity of gas injected into the tank 2, t₀ is the instant marking the start of the injection step, and t₁ is the instant marking the end of the injection step.

The maximum volume Vₘₐₓ can be expressed as follows:

$${V}_{max} = f ( {T}_{tank} ( {t}_{0} ) , {T}_{amb} , {P}_{disp} ( {t}_{0} ) ) \frac{Δ m}{Δ P}$$

where Tₜₐₙₖ is the temperature of the gas in the tank 2, T_{amb} is the ambient temperature in a region surrounding the tank 2, P_{disp} is the gas pressure at the dispenser 5, Δm is the quantity of gas injected into the tank 2 and ΔP is the increase in pressure in the tank 2.

Thanks to the knowledge of the pressure Pₜₐₙₖ of the gas in the tank 2, as determined hereinabove, the invention makes it possible to determine the hydraulic pressure losses between the filling station 1 and the tank 2. These are pressure losses associated with the hydraulic pipe 51 connecting the dispenser 5 to the tank 2 and the high-pressure hydraulic circuit inside the vehicle 4.

In particular, the invention makes it possible to calculate the head loss coefficient kᵥ by means of a function that is notably dependent on the pressure Pₜₐₙₖ of the gas in the tank 2, as calculated hereinabove. This function is also dependent on parameters relating to the gas and determined at the dispenser 5. These parameters include the flow rate \dot{m}, the pressure P_{disp} and the temperature Tdisp of the gas.

Thus, the head loss coefficient kᵥ can be expressed as follows:

$${k}_{v} = f ( \dot{m} , {P}_{disp} , {T}_{disp} , {P}_{tank} )$$

In the case of subsonic flow, namely when the pressure of the gas in the tank is at least a factor of two higher than the pressure P_{disp} of the gas at the dispenser 5, namely 2Pₜₐₙₖ(t)>P_{disp}(t), the head loss coefficient kᵥ can be expressed as follows:

$${k}_{v} ( t ) = \frac{\dot{m}}{514 \sqrt{{ρ}_{n} \frac{{P}_{disp} ( t ) - {P}_{tank} ( t )}{{T}_{disp} ( t )} {P}_{tank} ( t )}}$$

where Tdisp[K] is the temperature measured at the dispenser 5 and ρ_{N}[kg/m3] is the density of the gas at a temperature of 0° C. and a pressure of 1 atm (101.3 kPa).

In the case of supersonic flow, namely when the pressure Pₜₐₙₖ of the gas in the tank 2 is at least a factor of two lower than the pressure P_{disp} of the gas at the dispenser 5, namely 2Pₜₐₙₖ(t)<P_{disp}(t), the head loss coefficient kᵥ can be expressed as follows:

$${k}_{v} ( t ) = \frac{\dot{m}}{257 {P}_{disp} ( t ) \sqrt{\frac{{ρ}_{n}}{{T}_{disp} ( t )}}}$$

where Tdisp[K] is the temperature measured at the dispenser 5 and ρ_{N}[kg/m3] is the density of the gas at a temperature of 0° C. and a pressure of 1 atm (101.3 kPa).

If the geometry of the hydraulic pipe 51 connecting the dispenser 5 to the tank 2 remains unchanged, the head loss coefficient kᵥ must be a constant. A change to the geometry of the hydraulic pipe 51 may be caused by twisting or by the closing of a valve.

In order to obtain a value that remains constant in spite of the uncertainty regarding the measurements, statistical processing may be applied to the calculated values of the head loss coefficient kᵥ. For example, a time-based average may be applied,

$$< {k}_{v} > = \frac{1}{{t}_{1} - {t}_{0}} {\int }_{{t}_{0}}^{{t}_{1}} {k}_{v} ( t ) dt$$

By using the head loss coefficient kᵥ calculated hereinabove it is possible to determine, even in the absence of communication between the vehicle and a filling station, the pressure Ptank in a tank the characteristics of which are unknown.

For example, in the case of subsonic flow, which is the norm at the end of filling, it may be demonstrated that the pressure Ptank of the gas in the tank can be obtained from the following relationship:

$${P}_{tank} ( t ) = \frac{{P}_{disp} ( t )}{2} + \frac{\sqrt{66049 {ρ}_{N} {P}_{disp} {}^{2} {k}_{v}^{2} - \dot{m} {T}_{disp}^{2}}}{514 {k}_{v} \sqrt{{ρ}_{N}}} .$$

where Tdisp[K] is the temperature measured at the dispenser 5 and ρ_{N}[kg/m3] is the density of the gas at a temperature of 0° C. and a pressure of 1 atm (101.3 kPa).

While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the appended claims. The present invention may suitably comprise, consist or consist essentially of the elements disclosed and may be practiced in the absence of an element not disclosed. Furthermore, if there is language referring to order, such as first and second, it should be understood in an exemplary sense and not in a limiting sense. For example, it can be recognized by those skilled in the art that certain steps can be combined into a single step.

The singular forms “a”, “an” and “the” include plural referents, unless the context clearly dictates otherwise.

“Comprising” in a claim is an open transitional term which means the subsequently identified claim elements are a nonexclusive listing (i.e., anything else may be additionally included and remain within the scope of “comprising”). “Comprising” as used herein may be replaced by the more limited transitional terms “consisting essentially of” and “consisting of” unless otherwise indicated herein.

“Providing” in a claim is defined to mean furnishing, supplying, making available, or preparing something. The step may be performed by any actor in the absence of express language in the claim to the contrary.

Optional or optionally means that the subsequently described event or circumstances may or may not occur. The description includes instances where the event or circumstance occurs and instances where it does not occur.

Ranges may be expressed herein as from about one particular value, and/or to about another particular value. When such a range is expressed, it is to be understood that another embodiment is from the one particular value and/or to the other particular value, along with all combinations within said range.

All references identified herein are each hereby incorporated by reference into this application in their entireties, as well as for the specific information for which each is cited.

What is claimed is:

1. A method (10) for estimating the volume (V) of a pressurized gas tank (2) and the pressure (Pₜₐₙₖ) of the gas in said tank (2), the tank (2) being supplied by a dispensing station (1) comprising, in this order: a source (3) of said gas, a control valve (7) and a dispenser (5) which is connected to the tank (2), the method (10) comprising the following steps:
a) measuring (SO) a first value (P_{tank_mes}) for the pressure (Pₜₐₙₖ) of the gas in the tank (2) by measuring the pressure (P_{disp}) of the gas at the dispenser (5), the control valve (7) being closed,
b) injecting (S1) a quantity (Δm) of gas into the tank (2),
c) determining (S2) during the injection (S1) a value for the mass flow rate (\dot{m}), a value for the pressure (P_{disp}) and a value for the temperature (T_{disp}) of the gas at the dispenser (5); and a value for the ambient temperature (T_{amb}) in a region surrounding the tank (2),
d) measuring (S3) a second value (P_{tank_mes}) for the pressure (Pₜₐₙₖ) of the gas in the tank (2) by measuring the pressure (P_{disp}) of the gas at the dispenser (5), the control valve (7) being closed,
e) determining (S4) a maximum volume (Vₘₐₓ) corresponding to a first reference tank, and a minimum volume (Vₘᵢₙ) corresponding to a second reference tank,
f) determining (S5) the volume (V) of the tank (2) and the pressure (Pₜₐₙₖ) of the gas in the tank (2), through an iterative search for the root of a function (P) expressing the difference between the pressure (Pₜₐₙₖ) of the gas in the tank (2) and the second value (P_{tank_mes}) for the gas pressure (P_{disp}) measured at the dispenser (5) during the measurement (S3), the iterative search being performed in an interval ([Vₘᵢₙ, Vₘₐₓ]) that is defined between the minimum volume (Vₘᵢₙ) and the maximum volume (Vₘₐₓ).

2. The method (10) according to claim 1, wherein the maximum volume (Vₘₐₓ) and the minimum volume (Vₘᵢₙ) respectively have predefined fixed values.

3. The method (10) according to claim 1, wherein the maximum volume (Vₘₐₓ) and the minimum volume (Vₘᵢₙ) respectively have values calculated from a physical model in which the first reference tank is considered as having been filled adiabatically and the second reference tank is considered as having been filled isothermally.

4. The method (10) according to claim 1, wherein the iterative search comprises a step (S5a) of assigning an approximated value (Vi) to the volume (V) of the tank (2), the approximated value (Vi) being comprised between the maximum volume (Vₘₐₓ) and the minimum volume (Vₘᵢₙ).

5. The method (10) according to claim 1, wherein the iterative search comprises a step of dividing the interval ([Vₘᵢₙ, Vₘₐₓ]) into two sub-intervals defined with respect to the approximated value (Vᵢ), the iterative search also comprising a step of selecting one of said sub-intervals in which to search for the root of the function (P).

6. The method (10) according to claim 5, wherein the iterative search comprises a step (S5b) of calculating an approximated value (P_{tank_i}) for the pressure (Pₜₐₙₖ) of the gas in the tank (2), said approximated value (P_{tank_i}) being calculated from the approximated value (Vᵢ) for the volume (V).

7. The method (10) according to claim 6, wherein the iterative search comprises a step (S5e) of calculating the difference between the approximated value (P_{tank_i}) for the pressure (Pₜₐₙₖ) of the gas in the tank (2) and the second value (P_{tank_mes}) for the gas pressure measured at the dispenser (5) in step (S3).

8. The method according to claim 7, wherein the iterative search comprises a step (S5f) of incrementing or decrementing the approximated value (Vi) for the volume (V) when the difference between the approximated value (P_{tank_i}) for the pressure (Pₜₐₙₖ) of the gas in the tank (2) and the second value (P_{tank_mes}) for the gas pressure (P_{disp}) measured at the dispenser (5) in step (S3) is nonzero and above a predefined threshold.

9. The method according to claim 8, wherein,
when the approximated value (P_{tank_i}) for the pressure (Pₜₐₙₖ) of the gas in the tank (2) is higher than the second value (P_{tank_mes}) for the gas pressure (P_{disp}) measured at the dispenser (5) in step (S3), the approximated value (Vᵢ) for the volume (V) is incremented by a first predetermined quantity to give a new approximated value (Vᵢ₊₁) for the volume (V) of the tank (2), a new approximated value (P_{tank_i+1}) for the pressure (Pₜₐₙₖ) of the gas in the tank (2) being calculated from the new approximated value (Vᵢ₊₁) for the volume (V) of the tank (2), the new approximated value (Vᵢ₊₁) for the volume (V) of the tank (2) and the maximum volume (Vₘₐₓ) forming a new sub-interval in which to search for the root of the function (P),
when the approximated value (P_{tank_i}) for the pressure (Pₜₐₙₖ) of the gas in the tank (2) is the lower than the second value (P_{tank_mes}) for the gas pressure (P disp) measured at the dispenser (5), the approximated value (Vi) for the volume (V) of the tank (2) is decremented by a second predetermined quantity to give a new approximated value (Vᵢ₋₁) for the volume (V) of the tank (2), a new approximated value (P_{tank_i-1}) for the pressure (Pₜₐₙₖ) of the gas in the tank (2) being calculated from the new approximated value (Vᵢ₋₁) for the volume (V) of the tank (2), the minimum volume (Vₘᵢₙ) and the new approximated value (Vᵢ₋₁) for the volume (V) of the tank (2) forming a new sub-interval in which to search for the root of the function (P).

10. The method (10) according to claim 9, comprising successive incrementations of the approximated value (Vᵢ) for the volume (V) of the tank (2) to give successive new approximated values (Vᵢ₊₁) for the volume (V) of the tank (2), the method (10) also comprising successive calculations of approximated values (P_{tank_i}) for the pressure (Pₜₐₙₖ) of the gas in the tank (2) from the successive approximated values (Vi) for the volume (V) of the tank (2), the calculations being performed respectively in sub-intervals each formed between an approximated value (Vᵢ) for the volume (V) of the tank (2) and the maximum volume (Vₘₐₓ), the incrementations being repeated for as long as the difference between the approximated value (P_{tank_i}) for the pressure (Pₜₐₙₖ) of the gas in the tank (2) and the second value (P_{tank_mes}) for the gas pressure (P_{disp}) measured at the dispenser (5) is nonzero, and for as long as the difference between two successive approximated values (Vi) for the volume (V) of the tank (2) remains above a predefined threshold, the exact value (Vf) for the volume (V) of the tank (2) being determined by the last approximated value (Vi) obtained at the end of the last incrementation, the exact value (P_{tank_f}) for the pressure (Pₜₐₙₖ) of the gas in the tank (2) being calculated from the exact value (V_{f}) for the volume (V) of the tank (2).

11. The method (10) according to claim 9, comprising successive decrementations of the approximated value (Vᵢ) for the volume (V) to give successive new approximated values (Vᵢ₋₁) for the volume (V), the method (10) also comprising successive calculations of approximated values (P_{tank_i}) for the pressure (Pₜₐₙₖ) of the gas in the tank (2) from the approximated values (Vi) for the volume (V) of the tank (2), the calculations being performed respectively in sub-intervals each formed between the minimum volume (Vₘᵢₙ) and an approximated value (Vi) for the volume (V) of the tank (2), the decrementations being repeated for as long as the difference between the approximated value (P_{tank_i}) for the pressure (Pₜₐₙₖ) of the gas in the tank (2) and the second value (P_{tank_mes}) for the gas pressure (P_{disp}) measured at the dispenser (5) is nonzero, and for as long as the difference between two successive approximated values (Vi) for the volume (V) of the tank (2) remains above a predefined threshold, the exact value (Vf) for the volume (V) of the tank (2) being determined by the last approximated value (Vᵢ) obtained at the end of the last decrementation, the exact value (P_{tank_f}) for the pressure (Pₜₐₙₖ) of the gas in the tank (2) being calculated from the exact value (V_{f}) for the volume (V) of the tank (2).

12. A method for estimating hydraulic pressure losses between a pressurized gas dispensing station (1) and a tank (2) supplied by said pressurized gas dispensing station (1), the station (1) comprising, in this order: a source (3) of said gas, a control valve (7) and a dispenser (5) provided with a hydraulic pipe (51) connected to the tank (2), the method comprising a step of calculating a head loss coefficient between the hydraulic pipe (51) and the tank (2) using a function that is dependent upon the following parameters, determined at the dispenser (5): the flow rate (m), the pressure (Pdisp) and the temperature (Tdisp) of the gas; said function also being dependent upon the pressure (Ptank) of the gas in the tank (2) as calculated by iterative search according to the method of claim 1.
